(19) United States
(12) Patent Application Publication
(10) Pub. No.: US 2017/0111245 A1
(43) Pub. Date: Apr. 20, 2017

(54) PROCESS TRACES CLUSTERING: A HETEROGENEOUS INFORMATION NETWORK APPROACH

(71) Applicant: INTERNATIONAL BUSINESS MACHINES CORPORATION, ARMONK, NY (US)

(72) Inventors: VATCHE ISHAKIAN, CAMBRIDGE, MA (US); VINOD MUTHUSAMY, YORKTOWN HEIGHTS, NY (US); PHUONG NGUYEN, URBANA, IL (US); ALEKSANDER SLOMINSKI, YORKTOWN HEIGHTS, NY (US)

(21) Appl. No.: 15/087,488

(22) Filed: Mar. 31, 2016

Related U.S. Application Data
(60) Provisional application No. 62/241,282, filed on Oct. 14, 2015.

(51) Int. Cl. H04L 12/26; G06F 17/30; H04L 12/24

(52) U.S. Cl. CPC H04L 43/045; H04L 41/12; H04L 43/16; G06F 17/30598; G06F 17/30486; G06F 17/30312; G06F 17/30958; G06F 17/30867

(57) ABSTRACT

A computer-implemented method of generating process models from process event logs, including receiving an identification of node types and edge types of an application event log to generate a heterogeneous information network graph of the application event log, where node types include events and traces, where each trace is a finite sequence of event type nodes; reducing a number of event types of the set of input traces to generate clusters of new event types; and clustering the set of input traces to generate a plurality of disjoint partitions based on the clusters of new event types, where the clustering maximizes an average fitness of each partition and minimizes an average complexity of each partition, where each partition is a graph model of a process in the application event log.

### CROSS-REFERENCE TO RELATED APPLICATIONS

This U.S. non-provisional patent application claims priority from “Automatic Troubleshooting”, U.S. Provisional Patent Application No. 62/241,282 of Ishakian, et al., filed on Oct. 14, 2015, the contents of which are herein incorporated by reference in their entirety.

### TECHNICAL FIELD

Embodiments of the present disclosure are directed to process mining, and more specifically to using traces clustering to analyze event logs to produce comprehensible process models.

### DISCUSSION OF THE RELATED ART

Process mining is the task of extracting information from event logs, such as those generated from workflow management or enterprise resource planning (ERP) systems, to discover models of the underlying processes, organizations, and products. As the event logs often contain a large variety of process execution traces, the discovered models can be challenging to comprehend because of their complexity and inaccuracy. Trace clustering is among approaches that can address this situation by splitting the event logs into smaller subsets and applying process discovery algorithms on each subset, so that the discovered processes of the subsets are less complex and more accurate.

With advances in information technology, the world is becoming more digital and there are more and more real-world processes being executed electronically using information systems, including online shopping, airline ticket reservations, loan application processing, and various administrative procedures. These applications generate large volumes of data about the processes in the form of event logs that correspond to execution instances of a process. Each process instance corresponds to a trace that is an ordered list of activities or events, invoked by a process instance during its execution. With such data, it is possible perform process mining on the event logs to discover, i.e., to understand what is happening, monitor, i.e., to see if the executions follow what was agreed upon, and improve the processes, e.g., to redesign the process to avoid bottlenecks.

To perform these mining tasks, a process model, which is a graphical representation of a process, is obtained from the event logs. However, as the real-world processes often have high dimensionality, i.e., a large number of event types, and are flexible in terms of their executions, the event logs can contain a large variety of process instances. As a result, the discovered process models become more challenge to comprehend because of their complexity and inaccuracy, such that these models are usually referred to as spaghetti-like models. To address this situation, a common approach is to first do trace clustering to divide the event logs into smaller subsets, and then, discover the process model on each subset of traces. The motivation is that the traces in each subset are more coherent and similar to each other, and thus, the process model discovered from each subset will be less complex and more accurate.

Instead of designing new clustering algorithms for process traces, much related work on process traces clustering has focused on exploring new data representations of traces, and deriving new similarity measures between traces that can be used by off-the-shelf clustering algorithms.

These approaches, however, cannot capture the process-specific similarity between events. For example, events that are different but share the same underlining role, or belong to the same group of events, should still have a certain level of similarity. In another example, events (or activities) that are executed/generated by the same resource (or person) are also likely to be similar. Beside the ability to capture such semantic relationships, since additional information, such as organization, roles, products information, etc., about traces are usually available in real-world process traces, a desirable data model should also be extendable to capture the extra semantics inferred from such information. Beside the semantic gap, the related work, especially the edit distance-based approaches, are also not scalable. Since the similarities between every pairs of traces needs to be calculated and the complexity of edit distance-based measure is quadratic to the length of traces, as the real-world traces are often of high-dimensional, the similarity computation becomes very expensive. There have been efforts to apply standard dimension reduction techniques to process mining. However, those efforts are only limited to vector space model-based approaches, whose similarity calculation is not as expensive.

### SUMMARY

Exemplary embodiments of the disclosure provide systems and methods for analyzing process event logs as a heterogeneous information networks to capture their rich semantic meaning as node and edge types in the network, and thereby derive better process-specific features. In addition, exemplary embodiments provide a meta path-based similarity measure that considers node sequences in the heterogeneous graph and results in better clustering, and introduce a new dimension reduction method that combines topical similarity with regularization by process model structure to deal with event logs of high dimensionality.

According to an embodiment of the disclosure, there is provided a computer-implemented method of generating process models from process event logs, including receiving an identification of node types and edge types of an application event log to generate a heterogeneous information network graph of the application event log, where node types include events and traces, where each trace is a finite sequence of event type nodes, reducing a number of event types of the set of input traces to generate clusters of new event types, and clustering the set of input traces to generate a plurality of disjoint partitions based on the clusters of new event types, where the clustering maximizes an average fitness of each partition and minimizes an average complexity of each partition, where each partition is a graph model of a process in the application event log.

According to a further embodiment of the disclosure, the method includes filtering the events in the application event log to select those entries that contain attributes needed for generating process models.

According to a further embodiment of the disclosure, the method includes generating a set of meta-paths that connect nodes of a same type in the application event log.

According to a further embodiment of the disclosure, the method includes, if the number of nodes in the set of meta-paths is large, based on user provided cost/time constraints, determining a sample size of a reduced set of meta-paths.

According to a further embodiment of the disclosure, the method includes receiving a number of reduced dimensions.

According to a further embodiment of the disclosure, the method includes presenting a visualization of the plurality of disjoint partitions to a user, and prompting the user to either accept the plurality of disjoint partitions or to enter new parameters to repeat the generation of process models.

According to a further embodiment of the disclosure, clustering the set of input traces includes creating a hierarchy of the plurality of disjoint partitions by successively merging pairs of events that are closest to each other until all clusters have been merged into a single hierarchical cluster that contains all events, where each leaf node of the single hierarchical cluster is an event and a root of the single hierarchical cluster is the single hierarchical cluster formed by the last merge.

According to a further embodiment of the disclosure, clustering the set of input traces includes cutting the hierarchy to obtain a desirable number of clusters by finding a minimum similarity threshold so that a distance between any two events in the same cluster is no more than that minimum similarity threshold, where the desirable number of clusters is the same as the number of reduced event types.

According to a further embodiment of the disclosure, the method includes assembling event type nodes into a set of input traces.

According to another embodiment of the disclosure, there is provided a computer-implemented method of generating process models from process event logs, including receiving a heterogeneous information network (HIN) graph of an application event log and a set of meta-paths, where nodes of the HIN graph include event type nodes and trace type nodes, where each trace type node is associated with a finite sequence of event type nodes, and each meta-path of the set of meta-paths connect nodes of a same type in the HIN graph; calculating a path similarity between each pair of events type nodes in the HIN graph connected by a meta-path P using

$${σ}_{{P}_{EE}} ( {e}_{j} , {e}_{k} ) = \frac{2 \times \vert {Γ}_{P} ( {e}_{j} , {e}_{k} ) \vert}{\vert {Γ}_{P} ( {e}_{j} , {e}_{j} ) \vert + \vert {Γ}_{P} ( {e}_{k} , {e}_{k} ) \vert} ,$$

where eⱼ and eₖ represent event-type nodes and Γ_{P}(eⱼ, eₖ) is a set of paths from eⱼ to eₖ following meta-path P, reducing a number of dimensions of a matrix representation of event type nodes and the trace type nodes to generate a set of new dimensions for the event type nodes, calculating a similarity between each pair of event type nodes Sⱼₖ=sim′(eⱼ, eₖ)=(1−λ)×sim(eⱼ, eₖ)+λ×σ_{P}_{_{EE}}(eⱼ, eₖ), where sim(eⱼ, eₖ) is a similarity between eⱼ and eₖ on the set of new dimensions, λ is a user supplied parameter, and Sⱼₖ is an element of a similarity matrix defined by each pair of event type nodes on the set of new dimensions, merging each event eⱼ into a cluster associated with one of the new dimensions that contains an event closest to eⱼ, using ρ(eⱼ)=ρ(e*) with respect to e*=arg maxₑ_{ₖ}_{εE} sim′(eⱼ, eₖ), until all clusters have been merged into a single cluster that contains all events to create a hierarchy H in which each leaf node is an event and a root is a single cluster of the last merge, and cutting the hierarchy to obtain a desirable number of clusters by finding a minimum similarity threshold so that a distance between any two events in the same cluster is no more than that minimum similarity threshold, where the desirable number of clusters is the same as the number of new dimensions.

According to a further embodiment of the disclosure, the method includes assembling the event type nodes into a set of input traces, where the set of input traces is represented by a matrix M of size |T|×|E|, where |T| is a number of sets of traces, and |E| is a number of event type nodes, where each row of M is a trace vector t=(s₁, s₂, . . . , s_{|E|}) where

$${s}_{i} = \{ \begin{matrix}( 1 + log ( {f}_{{e}_{i} , t} ) ) \times log ( \frac{\vert T \vert}{{n}_{{e}_{i}}} ) & if {e}_{i} ∈ t , \\ 0 & otherwise .\end{matrix} , where$$

fₑ_{ᵢ}_{,t} is a normalized frequency of event eᵢ in trace t, and nₑ_{ᵢ}=|{tεT, eᵢεt}| is a popularity of event eᵢ across all traces.

According to a further embodiment of the disclosure, reducing a number of dimensions comprises calculating a matrix M′ of size |T|×κ, where κ<<|E| is a number of new dimensions that represents the original data on the new dimensions, where each row is a trace vector, and calculating a matrix W of size |E|×κ that represents a mapping of previous dimensions to the new dimensions κ, which are represented as a set of κ clusters C={Cᵢ}, 1≦i≦κ, and mapping ρ: E→C maps each event eεE to a cluster in C.

According to a further embodiment of the disclosure, sim(eⱼ, eₖ) is one of a cosine similarity or a Euclidean distance-based similarity.

According to a further embodiment of the disclosure, the method includes receiving an identification of nodes and edges of the application event log to generate the HIN graph of the application event log, and receiving an identification of node types of the nodes.

According to another embodiment of the disclosure, there is provided a non-transitory program storage device readable by a computer, tangibly embodying a program of instructions executed by the computer to perform the method steps for generating process models from process event logs.

### BRIEF DESCRIPTION OF THE DRAWINGS

FIG. 1(a) illustrates model process traces as a heterogeneous graphs, according to embodiments of the disclosure.

FIG. 1(b) illustrates an extended HIN model, according to embodiments of the disclosure.

FIG. 2(a) illustrates an original representation of a loan application process model, according to embodiments of the disclosure.

FIG. 2(b) shows the process model of FIG. 2(a) abstracted using fewer dimensions, according to embodiments of the disclosure.

FIG. 3 shows pseudocode of a greedy approximation algorithm that uses a bottom-up strategy to assign original events into clusters, according to embodiments of the disclosure.

FIG. 4 is a flowchart of a general process that generates business process clusters, according to an embodiment of the disclosure.

FIG. 5 is a block diagram that of the functioning of a system according to an embodiment of the disclosure.

FIG. 6 shows Table 1, which provides detailed properties about the datasets used to evaluate embodiments of the disclosure.

FIGS. 7(a)-(b) depict a conformance fitness analysis comparison between approaches, according to embodiments of the disclosure.

FIG. 8 shows Table 2, which compares the weighted structural complexity scores between approaches across different structural metrics, according to embodiments of the disclosure.

FIG. 9 shows Table 3, which compares structural complexity between approaches on Receipt Phase dataset across a varying number of clusters, according to embodiments of the disclosure.

FIGS. 10(a)-(b) illustrate a running time comparison between with and without dimension reduction, according to embodiments of the disclosure.

FIG. 11 shows Table 4, which compares fitness and structural complexity results between a DR-SPS approach according to embodiments of the disclosure.

FIG. 12 is a schematic of an exemplary cloud computing node that implements an embodiment of the disclosure.

FIG. 13 shows an exemplary cloud computing environment according to embodiments of the disclosure.

### DETAILED DESCRIPTION OF EXEMPLARY EMBODIMENTS

Exemplary embodiments of the disclosure as described herein generally include methods for a network approach to process traces clustering. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. In addition, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Embodiments of the present disclosure provide a new process traces clustering approach that can resolve both of the above issues. In particular, for the semantic gap issue, embodiments of the present disclosure provide a new data representation for process traces based on extendable heterogeneous information networks to capture the rich semantics of structural types of nodes and edges in the network. With this representation, users can intuitively select appropriate meta-paths between nodes in the network to model different semantic relationships between process traces. While the selected meta-paths can be used to directly calculate the similarity between traces using existing path similarity measures, embodiments of the present disclosure provide a new similarity measure for process traces that combine the event-to-event relationships captured by existing path similarity measures and the sequential similarity between traces captured by generic edit-distance. For the complexity issue of edit distance-based approaches, embodiments of the present disclosure provide a new dimension reduction method that is tailored for process traces that models dimension reduction as an optimization task and provides an objective function that can maximize both topical similarity and process model-based relationships between events of the same dimension. Since such an optimization task is NP-hard, embodiments use a greedy approximation algorithm. Extensive evaluations on real-world and synthetic process traces were performed to verify the effectiveness and efficiency of an approach according to an embodiment of the disclosure.

### Preliminaries: Heterogeneous Information Network

A heterogeneous information network is a information network or graph with multiple types of nodes (vertices) and/or multiple types of links (edges).

DEFINITION 1: A Heterogeneous Information Network (HIN) is a directed graph G=(V, E) with a node type mapping function φ: V→A, where A, |A|>1, is the set of node types, and a edge type mapping function ψ: E→R, where R, |R|>1, is the set of edge types.

An example of an HIN is bibliographic network that contains multiple types of nodes, such as papers (P), venues (C), authors (A), and multiple types of edges, such as submission (i.e., between P and C), citation (i.e., between P and P), etc.

Multiple paths may exist between two nodes in an HIN. A meta-path, described by a sequence of relations in the HIN that connect two types of nodes, can capture the underlining semantic of each path. For example, APA may represent the co-author relationship between authors, or ACP may represent a paper submission relationship.

To measure similarity between nodes in HINs, existing similarity measures, such as a random walk-based similarity, can be applied to the projected homogeneous network. However, existing measures favor objects with high degree or high connectivity. A similarity measure was proposed that takes advantage of the rich semantic structure in the network and captures the true peer similarity between nodes in HINs.

DEFINITION 2: Given a symmetric meta-path P, a path similarity (PathSim) between two objects of the same type x and y via meta-path P, denoted as σ_{P}(x; y), is defined as:

$${σ}_{P} = \frac{2 \times \vert {Γ}_{P} ( x , y ) \vert}{\vert {Γ}_{P} ( x , x ) \vert + \vert {Γ}_{P} ( y , y ) \vert} ,$$

where Γ_{P}(x, y) is the set of paths from x to y following metapath P.

### Task Definition

Consider a set of process traces T. Each trace tεT includes a finite sequence of events t=(e₁, e₂, . . . , eₙ), eᵢεE, n>0, where E is the set of all event types. The number of events per trace n may be different from trace to trace. For each event eᵢ in a trace t, there is an associated resource rⱼεR that generates/executes the event, with R being the set of all resources.

As highlighted above, discovering process models using the entire set of process traces may result in spaghetti-like model. Clustering process traces T into non-overlapping subsets {Tᵢ} of clusters, resulted in clusters that better represent the underlying process model.

Unlike classic data clustering tasks, where the objective is either maximizing the precision and recall, in case ground-truth labels are available, or minimizing the intra-cluster and maximizing the inter-cluster distances, in case the ground-truth labels are not available, the effectiveness of clustering results in process mining is measured by how traces in resulting clusters can generate process models that have (1) a high degree of fitness, which quantifies how the discovered model can accurately reproduce the process instances from the event logs, and (2) low degree of structural complexity. Embodiments use two widely used metrics in other process traces clustering work: (1) weighted average fitness, denoted as AvgFitness; and (2) weighted average structural complexity, denoted as AvgComplexity, as the clustering quality metrics, where the weights are based on the size of each resulting cluster. Formally, the process trace clustering task is defined as follows:

DEFINITION 3: Let T be a set of process traces, E a set of events, and R a set of resources. A process traces clustering is a k-partition {Tᵢ} of T, k≧2: |{Tᵢ}|=k; Tᵢ∩Tⱼ=0, ∀1≦i, j≦k that maximizes the average fitness AvgFitness({Tᵢ}), and minimizes the average structural complexity AvgComplexity({Tᵢ}).

Similar to other clustering tasks, the effectiveness of process trace clustering results largely depend on how one defines the notion of similarity between traces.

According to embodiments, a similarity measure sim is derived that can be used with off-the-shelf clustering algorithms to produce results of high fitness and low structural complexity. Let Cₛᵢₘ^{k}(T)={Tᵢ} be the k-clustering result of process traces T by applying clustering algorithm C using similarity measure sim on T. Formally, the task is defined as follows:

DEFINITION 4. Let T be a set of process traces, E a set of events, R a set of resources, and C a clustering algorithm. A process trace similarity is a trace similarity measure sim(tᵢ; tⱼ), (tᵢ, tⱼ)εT that maximizes the AvgFitness and minimizes the AvgComplexity of clustering result Cₛᵢₘ^{k}(T).

### Modeling Process Traces as HIN

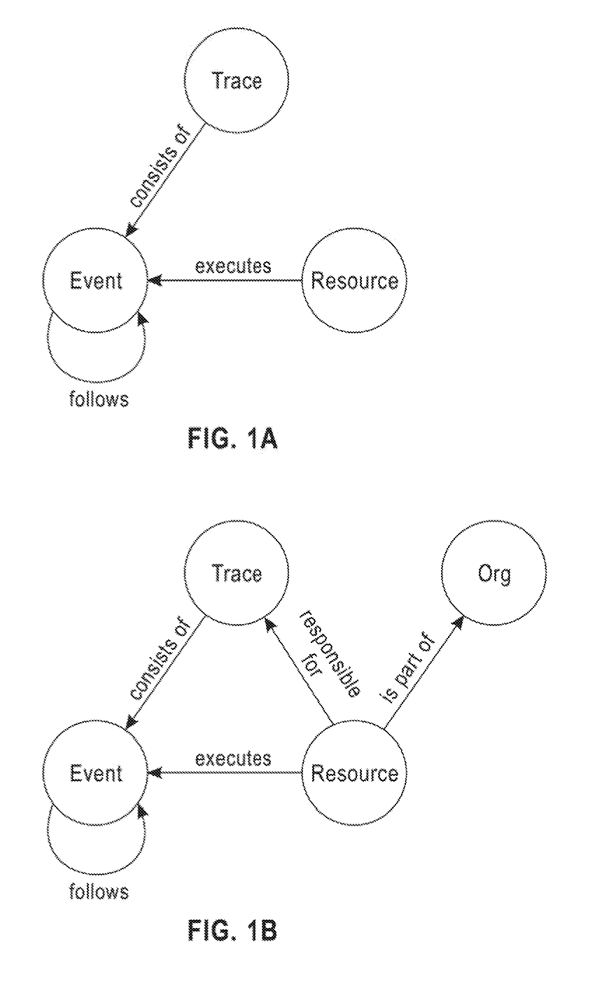

Motivated by the ability of using HIN to capture the peer similarity between nodes in other domain, embodiments of the present disclosure model process traces as a heterogeneous graph G=(V, E), as shown in FIG. 1(a), with the set of nodes V=T∪E∪R that includes three node types: trace, event, and resource. The set of edges E outline different types of interactions between different node types. Embodiments define the following non-limiting list of edge types R:

consist-of: An event is a part of a trace;

follow-up: An event follows another event in a trace;

execute: An event is executed/generated by a resource;

responsible-for: A resource is responsible for a trace.

These edge relations are generic enough to capture a wide variety of traces from different business process domains. Nevertheless, an HIN model according to an embodiment of the disclosure can be augmented with additional types of nodes and edges targeting a specific business process domain. For example, an extended HIN model, shown in FIG. 1(b), includes an additional node type “Department”, and an edge type “is-part-of” which specifies the resource's belonging to the department relationship.

According to embodiments, given an HIN model described above, the following non-limiting list of meta-paths can be defined.
TET: Meta-path between two traces that share common event(s);
TRT: Meta-path between two traces that share common resource(s) executing events;
TEET: Meta-path between two traces that consist of consecutive events;
TERET: Meta-path between two traces that consist of events executed by the same resource.

### Meta-Path Based Similarity Measures

According to an embodiment of the disclosure, by modeling process traces as a HIN, a PathSim-based Similarity Measure is a similarity calculated using the similarity measure between trace-typed nodes in the HIN. In particular, according to embodiments, a PathSim similarity based on multiple meta-paths can be used.

It has been shown that a linear combination of multiple meta-paths results in better outcome than that of an individual meta-path. Thus, according to embodiments, PathSim similarities obtained by individual meta-paths are combined using the following linear formula:

σ*(x,y)=Σ_{P}_{ᵢ}wᵢ×σ_{P}_{ᵢ}(x,y), (1)

where σ_{P}_{ᵢ}(X, y) is the PathSim-based similarity between two traces x and y via meta-path Pᵢ, and wᵢ is the weight associated with meta-path Pᵢ. Embodiments assume that meta-path selections are performed based on user guidance.

After calculating the PathSim similarity between every pair of traces using EQ. (1), an off-the shelf clustering algorithm can be used to cluster the input process traces.

Modeling process traces as an HIN can capture a rich semantics of structural types of nodes and edges in the network. HINs, however, do not maintain the sequential order of events in each process trace. As a result, PathSim does not measure the similarity between traces that share similar execution order of events. For example, a PathSim based on a TEET meta-path can represent only the sequential relationship between two consecutive events. Since traces comprise a sequence of multiple events, traces sharing the same sequential execution should typically be “more” similar than traces that are not. A similarity measure should be able to capture the similarity between two sequences of events, i.e., two traces, in an HIN.

Edit distance similarity measures can quantify how similar two sequences are by counting the minimum number of operations required to transform one sequence into the other. Edit distance has shown its effectiveness in measuring similarity between sequence-like data traces in multiple domains, such as text mining, process mining, and bioinformatics.

Embodiments of the disclosure can provide a new similarity measure for HIN, referred to as SeqPathSim, that combines the rich semantic relationships between nodes captured by PathSim with the sequential similarity captured by edit distance. According to embodiments, SeqPathSim uses a generic edit-distance.

It is known that the performance of edit distance depends on how the cost of editing operations, such as replace, delete, and insert, is defined. For example, using a unit cost, such as Levenshtein's distance, has been shown to be effective in many string similarity tasks. Embodiments of the disclosure consider two types of editing costs: insertion/deletion cost, which is the cost to insert or delete an event before or after another event, and replacement cost, which is the cost to replace an event by another event. For insertion/deletion cost, embodiments can use the PathSim based similarity via an EE metapath, which include the paths between an event that follows another event, since this meta path captures how likely an event is executed before/after another event. For replacement cost, embodiments can use a combination of the PathSim based similarity via ERE, which is an Event-Resource-Event metapath that represents two events that are executed by the same resource, and ETE, which is an Event-Trace-Event metapath that represents events that are part of the same trace, since these meta-paths capture how likely two events are the same in general.

Similar to generic edit-distance, a sequential path similarity measure, denoted as SeqPathSim, between two traces x=(a₁, a₂, . . . , aₘ) and y=(b₁, b₂, . . . , bₙ), where aᵢ, bⱼεE, 1≦i≦m, 1≦j≦n, generates a matrix vₘₙ(x, y), or v_{m,n} for short, that is defined by the following recursive formula:

$${v}_{m , n} = \{ \begin{matrix}{v}_{m - 1 , n - 1} & for {a}_{m} = {b}_{n} , \\ {min}_{v} & for {a}_{m} \neq {b}_{n} ,\end{matrix} \\ with \text{:} \\ {min}_{v} = \{ \begin{matrix}{v}_{m - 1 , n} + {σ}_{{P}_{EE}} ( {a}_{m} , {b}_{n} ) \\ {v}_{m , n - 1} + {σ}_{{P}_{EE}} ( {a}_{m} , {b}_{n} ) \\ {v}_{m - 1 , n - 1} + {σ}_{{P}_{ERE} , {P}_{ETE}} ( {a}_{m} , {b}_{n} )\end{matrix} . \qquad ( 2 )$$

### Optimizing SeqPathSim for High-Dimensional Process Traces

A SeqPathSim measure according to embodiments can leverage both the rich semantic relationships between nodes captured by PathSim and the sequential similarity by edit-distance, but also inherits the performance characteristics of edit distance-based measures. Recall that the complexity of a generic edit-distance is O(m×n), where m and n are the lengths of two compared sequences. The situation is further complicated by the need to calculate the similarities between every pairs of traces. Clustering real world traces that are often of high dimensionality, including up to hundreds of events per process trace, using a SeqPathSim according to embodiments can create computational bottlenecks.

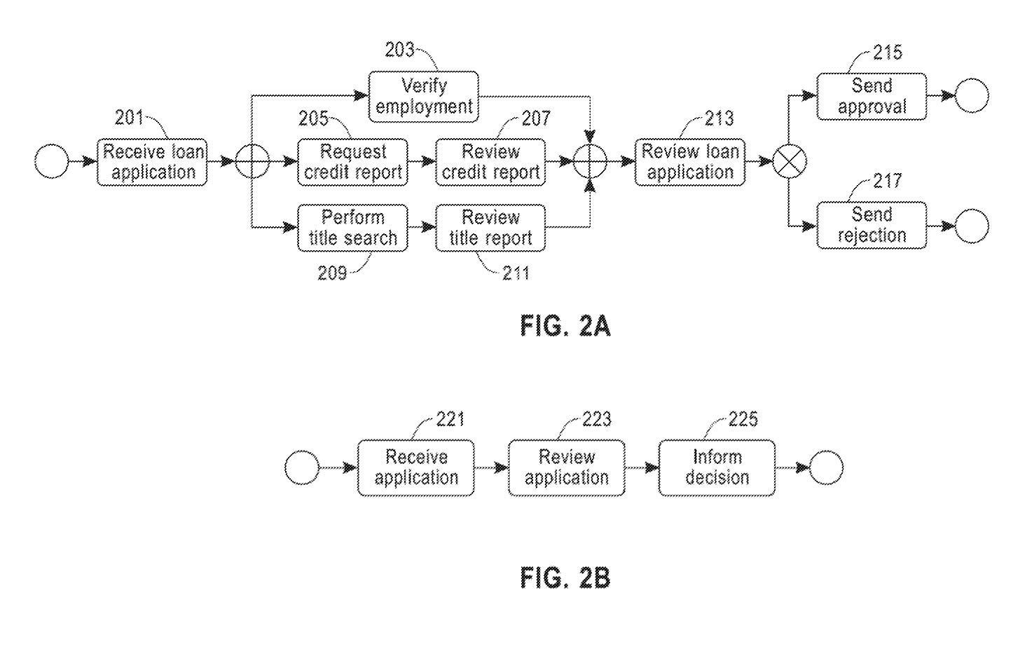

Despite of the high number of dimensions, the comparing process traces do not require the traces to be represented at the fine-grained level of events. For example, FIG. 2(a) illustrates an original representation of a loan application process model which includes 9 types of events, receive loan application 201, verify employment 203, request credit report 205, review credit report 207, perform title search 209, review title report 211, review loan application 213, send approval 215, and send rejection 217. However, at a higher level of abstraction, the loan application process essentially includes three steps: receiving the application 221, reviewing the application 223, and informing a decision 225, where reviewing the application 223 includes steps 203 through 213, and informing a decision 225 includes both sending approval 215 and sending rejection 217. Therefore, the process model in FIG. 2(a) can be abstracted using fewer dimensions, i.e., three dimensions, as shown in FIG. 2(b). When using the new representation, it is still possible to compare and differentiate between process traces, that is, traces of applications under review vs. those already informed of decisions. In addition, the performance of a SeqPathSim on the new dimensions will be improved due to the decrease in dimensionality. In FIG. 2(b), the performance is improved by two thirds.

### Traces Representation for Dimension Reduction

According to embodiments of the disclosure, before applying dimension reduction techniques to process traces, there should be an appropriate data representation for traces. The most common representation is based on a vector space model, in which each trace t is represented as a vector t=(s₁, s₂, . . . , s_{|E|}), in which the value of each dimension sᵢ is associated with a type of event eᵢεE and equals the normalized frequency of the event eᵢ in the trace t: sᵢ=fₑ_{ᵢ}_{,t}. This representation, although capturing the “local” importance of each event type to a trace via fₑ_{ᵢ}_{,t}, does not capture the “specificity” of each event type across all the traces. Taking the process model in FIG. 2(a) as an example, since the event “Receive loan application” appear in almost all traces, as it is the entry point of the process, it becomes less important as a differentiator between traces, i.e., has low specificity.

Embodiments of the disclosure can provide a new data representation for process traces that captures both the local importance of each event and its specificity to a trace. In addition to a trace's event frequency, embodiments can consider the popularity of each event across all traces: nₑ_{ᵢ}=|{tεT, eᵢεt}|. Intuitively, the higher nₑ_{ᵢ} is, the more popular the event eᵢ is and thus, the less specificity it is to a trace. As a result, according to embodiments of the disclosure, the value of each dimension in trace's vector sᵢ is based on a combination of an event's frequency fₑ_{ᵢ}_{,t}, i.e., the event's local importance, and inverse event popularity, which represents specificity. According to embodiments of the disclosure, a new calculation of sᵢ can be defined as follows:

$${s}_{i} = \{ \begin{matrix}( 1 + log ( {f}_{{e}_{i} , t} ) ) \times log ( \frac{\vert T \vert}{{n}_{{e}_{i}}} ) & if {e}_{i} ∈ t , \\ 0 & otherwise .\end{matrix} \qquad ( 3 )$$

According to embodiments, having represented process traces as vectors, the set of input traces T can be represented as a large matrix M, whose size is |T|×|E| and each element Mᵢⱼ, 1≦i≦|T|, 1≦j≦E, is the value of the j-th dimension, the dimension associated with event type eⱼ in the i-th trace.

### Process Model-Regularized Trace Dimension Reduction

According to embodiments, off-the-shelf dimension reduction techniques can be applied to matrix M, such as non-negative matrix factorization (NMF), principle component analysis (PCA), or singular value decomposition (SVD), among others. The results of those techniques often include a matrix M′, whose size equals |T|×κ, κ<<|E|, with κ as the number of new dimensions that represents the original data on the new dimensions, where each row is a trace vector, and a matrix W, whose size equals |E|×κ, that represents the mapping of the old dimensions to the new ones, i.e., each row is appropriate to the distribution of an event over the set of new dimensions.

According to embodiments of the disclosure, the results of existing techniques should not be used directly for an edit distance-based approach like SeqPathSim. According to embodiments of the disclosure, while SeqPathSim requires the input traces to be in form of sequences of events in the new dimensions, the above results only provide the “soft” mappings from the input events to the new dimensions in form of matrix W. Therefore, W should be transformed into a “hard” assignment of the original events into the new dimensions. Formally, according to embodiments, if κ new dimensions are represented as a set of κ clusters C={Cᵢ}, 1≦i≦κ, then a one-to-one mapping function ρ: E→C can be derived that maps each event eεE to a cluster in C. A mapping function ρ according to an embodiment can maximize the collective similarities between pairs of events that belong to the same cluster.

This mapping can be represented as an optimization with the following objective function:

arg max_{ρ}Σ_{ρ(e}_{ⱼ}_{)=ρ(e}_{ₖ}₎sim(eⱼ,eₖ) (4)

where sim(eⱼ, eₖ) is a similarity between eⱼ and eₖ on the new dimensions, such as a cosine similarity or a Euclidean distance-based similarity.

Deriving a “hard” assignment solely based on the result of the existing dimension reduction techniques, however, ignores the information about the relationships between events in a process model. According to embodiments, a process model can be obtained by projecting the process traces' heterogeneous graph G=(V, E) onto the set of event nodes E, denoted as G_{E}=(V_{E}, E_{E}). Because a process model according to an embodiment can capture the follow-up relationships between events, since edge weights in a process model represent the number of times an event follows another event in a trace, it can provide strong indication in assigning events to clusters. For example, events that are frequently following each other are likely to be in the same cluster. Therefore, according to embodiments, another component, denoted as Δ, is added to the objective function in EQ. (4) to account for the regularization based on the process model. According to an embodiment, Δ is used to maximize the collective similarities between pairs of events that follow one or the other in a process execution model. According to an embodiment, a new objective function for finding an optimal mapping ρ is as follow:

arg max_{ρ}(1−λ)×Σ_{ρ(e}_{ⱼ}_{)=ρ(e}_{ₖ}₎sim(eⱼ,eₖ)+λ×Δ, (5)

with

Δ=Σ₍ₑ_{ⱼ}_{,e}_{ₖ}_{)εE}_{_{E}}w(eⱼ,eₖ)×sim(eⱼ,eₖ),

where w(eⱼ, eₖ) is the weight of the edge between eⱼ and eₖ in process model V_{E}, and λ is a user specified parameter to tune the preference between the statistical similarity on the new dimensions, i.e., the first component, and the regularization based on the process model, i.e., the second component.

The optimization in EQ. (5) is a variant of a set partitioning task and finding a feasible solution for such a optimization is NP-hard. Therefore, according to embodiments, a “greedy” algorithm is used to solve for the above optimization. First, a similarity matrix S is calculated from

Sⱼₖ=sim′(eⱼ,eₖ)=(1−λ)×sim(eⱼ,eₖ)+λ×σ_{P}_{_{EE}}(eⱼ,eₖ), (6)

where σ_{P}_{_{EE}} (eⱼ, eₖ) is a PathSim-based similarity between eⱼ and eₖ via meta-path EE, which is used to account for the sequential relationship between events in the process model, i.e., σ_{P}_{_{EE}} (eⱼ, eₖ) can be considered as the local regularization term, similar to the role of Δ in EQ. (5), sim′(eⱼ, eₖ) is the new similarity measure between events that combines both statistical similarity, i.e., sim(eⱼ, eₖ), and sequential similarity, i.e., σ_{P}_{_{EE}}(eⱼ, eₖ). Then, instead of finding a solution that optimizes the global objective, as in EQ. (5), an embodiment uses a local objective function where an event eⱼ is assigned to a cluster, i.e., a new dimension, that contains the event closest to eⱼ:

ρ(eⱼ)=ρ(e*) with respect to e*=arg maxₑ_{ₖ}_{εE}sim′(eⱼ,eₖ). (7)

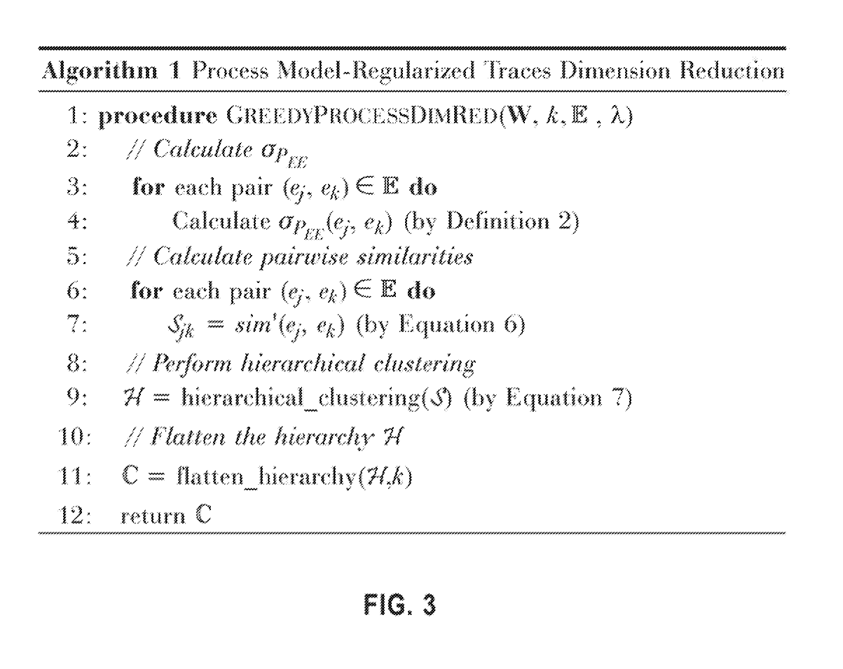

According to an embodiment of the disclosure, a greedy approximation algorithm, whose pseudocode is shown in FIG. 3, uses a bottom-up strategy, similar to that of an agglomerative clustering algorithm, to assign original events into clusters, i.e., new dimensions. First, at lines 3-4 and 6-7, a PathSim-based similarity σ_{P}_{_{EE}} and a similarity matrix S are calculated between all events in E using EQ. (6). Next, at line 9, using EQ. (7), each event is treated as a singleton cluster and pairs of events that are closest to each other are successively merge, or agglomerated until all clusters have been merged into a single cluster that contains all events. This step, which can use an off-the-shelf hierarchical clustering algorithm, creates a hierarchy H, where each leaf node is an event and the root is the single cluster of the last merge. At line 11, a final step is to cut the hierarchy at some point to obtain the desirable number of clusters K. While there are a number of criteria that can be used to decide the cutting point on the hierarchy, embodiments of the disclosure use a simple approach that is based on finding a minimum similarity threshold so that the distance between any two events in the same cluster is no more than that threshold, and no more than κ clusters are formed.

### Processes

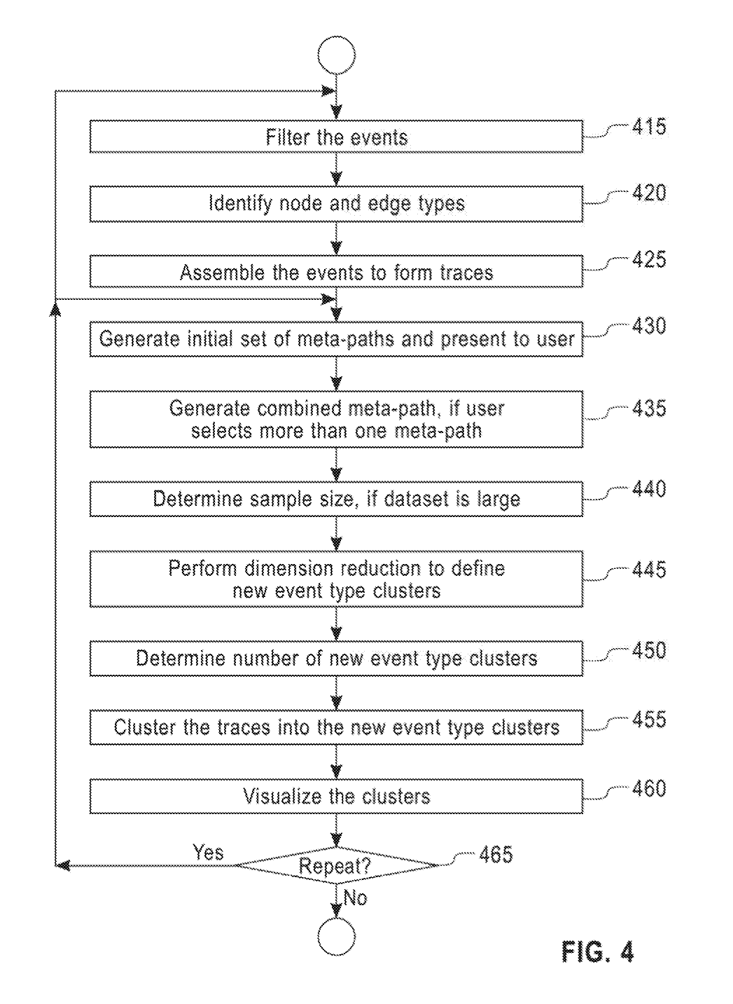

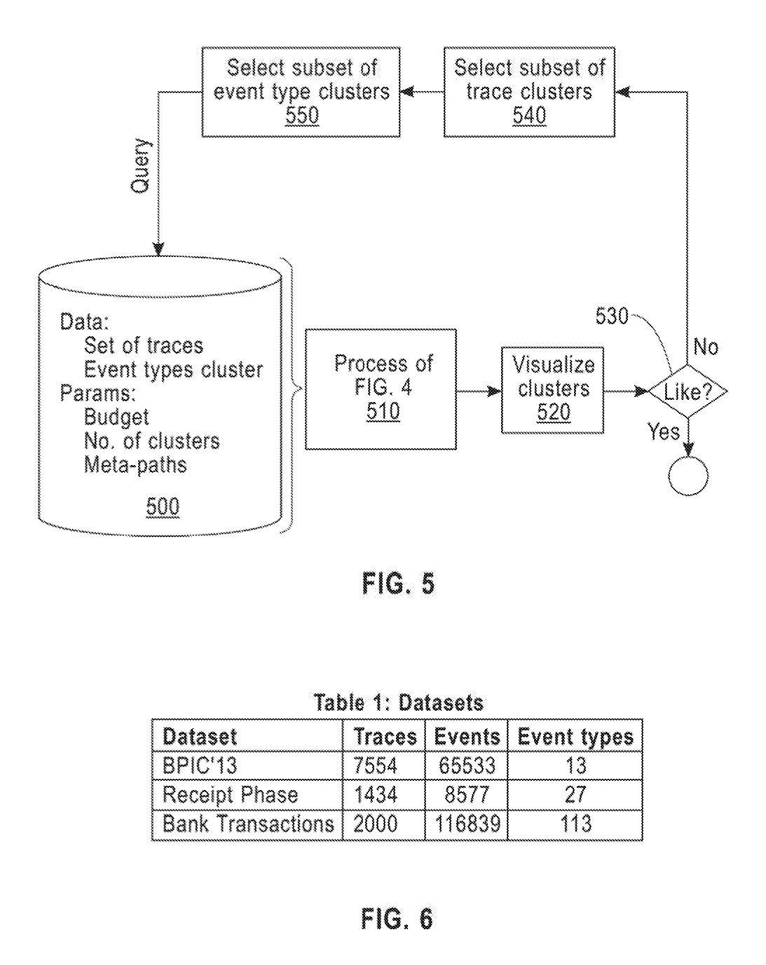

FIG. 4 is a flowchart of a general process according to an embodiment of the disclosure that generates business process clusters. A process according to an embodiment is generally an iterative process which relies on user feedback and allows the user to go back and forth between steps. Referring now to the figure, given a set of application level event logs that contain different metadata that may or may not be useful for clustering, a process begins at step 415 with an initial filtering of the events by a user to decide if the logs contain the necessary attributes. The attributes include an eventID, which is a description of the activity, a resourceID, which is a description of the resources, a timestamp, and a traceID that identifies which trace this event belongs to. At step 420, the user identifies node and edge types. At step 425, events are assembled together to form traces, if they were not previously assembled. Then, based on the node and edge type identifications, an initial set of meta-paths are generated and presented to the user at step 430, who can select, modify, delete and manually add additional meta-paths. If, at step 435, the user selects more than one meta-path, then a combined meta-path is generated. At step 440, if the dataset is too large as determined from user provided cost/time constraints, a reduced size of the data is determined for sampling from the dataset, so that the clustering, i.e. dimension reduction, can execute within the user specified budget constraint. A dimensionality reduction algorithm on event types is used at step 445 to define clusters of new event types. At step 450, the user is asked to input a maximum number of reduced dimensions, as the dimensionality reduction algorithm may generate more new event type clusters than a user wishes. Then, an off the shelf trace clustering algorithms is used at step 455 to cluster the traces according to the new event types, and at step 460, the clusters are visualized and the user can decide at step 465 whether to modify the system parameters and repeat the process again. Depending on the input from the user, control may return to step 430 to generate new meta-paths, or to step 415, to re-filter the events.

FIG. 5 is a block diagram that provides a high level illustration of the functioning of a system according to an embodiment of the disclosure. Block 500 represents an initial set of traces that have been filtered, an initial set of meta-paths provided to a user who may select, modify, delete and add, and a set of parameters entered by the user, such as number of clusters, budget, etc. The system then proceeds to run process steps 430 to 455 illustrated in FIG. 4, represented by block 510, which generates a set of clusters which can be visualized at block 520. If the users decides at block 530 that all or a subset of visualized clusters are deemed to be unacceptable or require further analysis, then that subset can be selected at block 540 along with additional changes to the meta-paths or other parameters at block 550. Given the new set of information, a system according to an embodiment processes the new results and provides the users with new set of clusters. The iteration is completed once the user decides that the results are satisfactory.

### Experimental Evaluation

In this section, the efficacy and the efficiency of methods according to embodiments are evaluated using multiple, real-world and synthetic, datasets spanning different business process domains. Experiments were conducted on a Windows 7, Intel Core i7 CPU with 16 GB of memory.

### Datasets:

The following publically available datasets were used which range from relatively few to many dimensions. All datasets are publically available at https://data.3tu.nl/repository/collection:event_logs. Table 1, shown in FIG. 6, provides detailed properties about the datasets.

The BPIC' 13 dataset comprises logs representing the Volvo's IT incident and problem management process.

The RECEIPT PHASE dataset comprises logs representing the record of execution of the receiving phase of a building permit application process in an anonymous municipality.

The BANK TRANSACTIONS dataset comprises synthetically generated logs that represent a large bank transaction process.

### Evaluation Metrics:

Embodiments of the disclosure cluster event logs to group traces that share similar execution patterns, thus enabling discovery of process models with a high degree of fitness. The fitness of a process model according to an embodiment quantifies the extent to which a discovered model can accurately reproduce the traces recorded in the log. In addition, a good result should also include clusters whose process models are simple and compact, i.e., low complexity.

Instead of using conventional metrics for generic clustering results, such as average cluster density, average inter- or intra-cluster distance, embodiments of the disclosure evaluate process traces clustering using process-specific metrics. In particular, embodiments of the disclosure may use two metrics that have been extensively used in other process traces clustering work: weighted average conformance fitness, denoted herein as AvgFitness, and weighted average structure complexity, denoted herein as AvgComplexity.

According to an embodiment of the disclosure, for each cluster in a clustering result, a process model is generated using a heuristic mining algorithm and then converted to a Petri-Net model for conformance analysis. According to an embodiment of the disclosure, the conformance fitness score of a discovered process model is the fraction of traces in the event logs that can be fully replayed on that model. A process model has a perfect fitness score if all traces in the log can be replayed by the model from beginning to end. The weighted average conformance fitness over a set of k clusters {Tᵢ} of traces is defined as

$$AvgFitness = \frac{{Σ}_{i = 1}^{k} \vert {T}_{i} \vert F i t n e s s ( {T}_{i} )}{{Σ}_{i = 1}^{k} \vert {T}_{i} \vert} ,$$

where Fitness(Tᵢ) is the fitness score of a cluster of trace Tᵢ. The higher a fitness score is, the more accurate is the process model of a given cluster. The structural complexity is measured based on the complexity of the graphical representation of a process model. According to an embodiment, given a process model represented as a Petri net, the complexity is measured by counting the number of control-flows, AND-joins/splits, and XOR-joins/splits that appear in the process model. Similar to AvgFitness, AvgComplexity is a weighted average of the complexity metrics based on the cluster sizes. A lower structural complexity score implies a simpler, more compact model, which is potentially more understandable by humans.

An evaluation according to an embodiment uses two publically available plugins from the ProM framework, disclosed in van Dongen, et al., “The ProM framework: A new era in process mining tool support”, Applications and Theory of Petri Nets, pages 444-454, Springer, 2005, the contents of which are herein incorporated by reference in their entirety, for fitness and complexity analysis: (1) the conformance checker plugin to measure the fitness of a generated process model; and (2) the Petri-Net Complexity Analysis plugin to analyze the structural complexity of a process model. After fitness and complexity scores are calculated for each cluster, the final scores are calculated as the average score over all clusters, weighted by clusters' sizes.

### Trace Clustering:

Embodiments of the disclosure evaluate the performance of the following traces clustering approaches:
ED: A baseline approach according to an embodiment is a context-aware edit distance-based clustering where the costs of editing operations derived from tri gram-based of consecutive events. Embodiments use an implementation of ED included in the ProM framework.
PS: A PathSim-based approach according to an embodiment described above where the similarity between traces is derived from a PathSim similarity between trace nodes in HIN. Meta-paths used for trace-to-trace similarity include: TET, TRT, TEET, TERET.
SPS: A SeqPathSim-based approach according to an embodiment described above where the similarity between traces is derived from a SeqPathSim similarity between sequences of event nodes in HIN.
   DR-SPS: This is an SPS approach according to an embodiment with dimension reduction method described above.

According to embodiments, for all approaches, hierarchical clustering is used as the clustering algorithm in the final step, after the similarities between each pair of traces have been calculated.

### Conformance Fitness Comparison

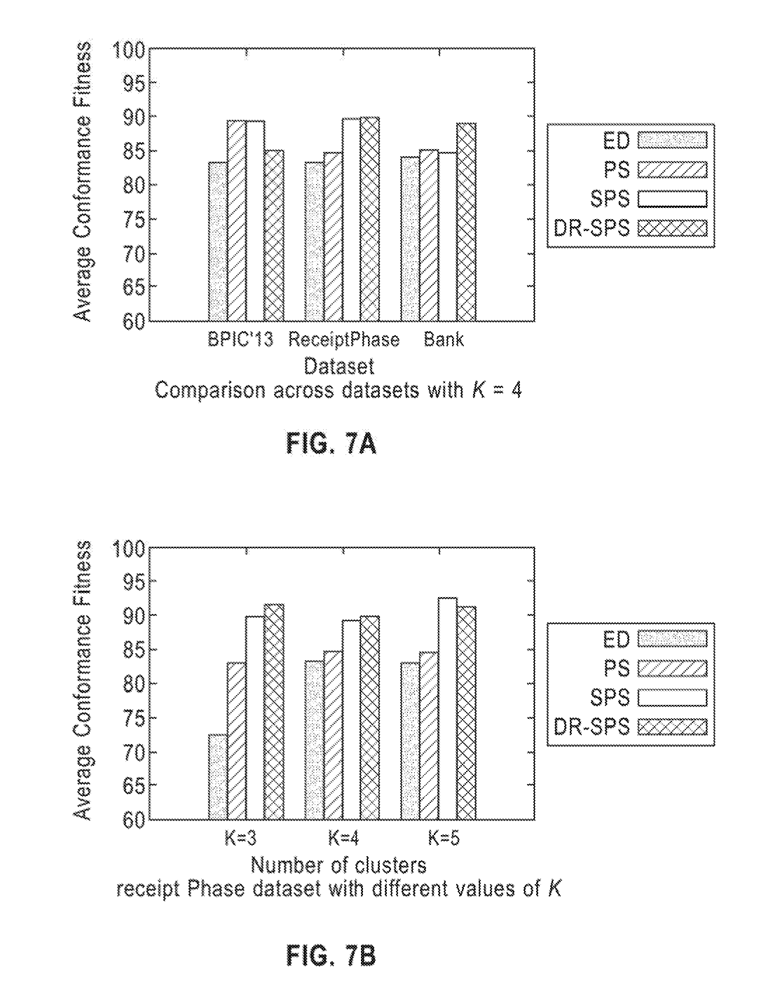

FIGS. 7(a)-(b) depict a conformance fitness analysis comparison between approaches. FIG. 7(a) shows the weighted average conformance fitness results across different datasets where the number of clusters k=4. FIG. 7(b) shows the weighted average conformance fitness results for the Receipt Phase dataset while varying the number of clusters k. Similar results were observed with the other datasets but were omitted for clarity. The figures show that a PS approach according to an embodiment, the only non-edit distance approach being evaluated, performs quite well compared with other edit distance-based approaches, and also clearly outperforms the baseline ED approach. This verifies the effectiveness of using a PathSim similarity approach according to an embodiment to capture the similarity between traces. A DR-SPS approach according to an embodiment, although being applied to the traces after dimension reduction, still performs well compared with a SPS approach according to an embodiment without dimension reduction, and even better in some cases. This is interesting, considering the primary purpose of dimension reduction is to improve efficiency, not effectiveness. This result can be explained by the fact that a DR-SPS approach according to an embodiment can intelligently group traces that include different events but in the same new dimension, and are thus highly correlated, into the same cluster. According to an embodiment, the efficiency gained by dimension reduction is evaluated in the following subsections. All approaches according to embodiments outperform the baseline edit distance-based approach ED.

### Structural Complexity Comparison

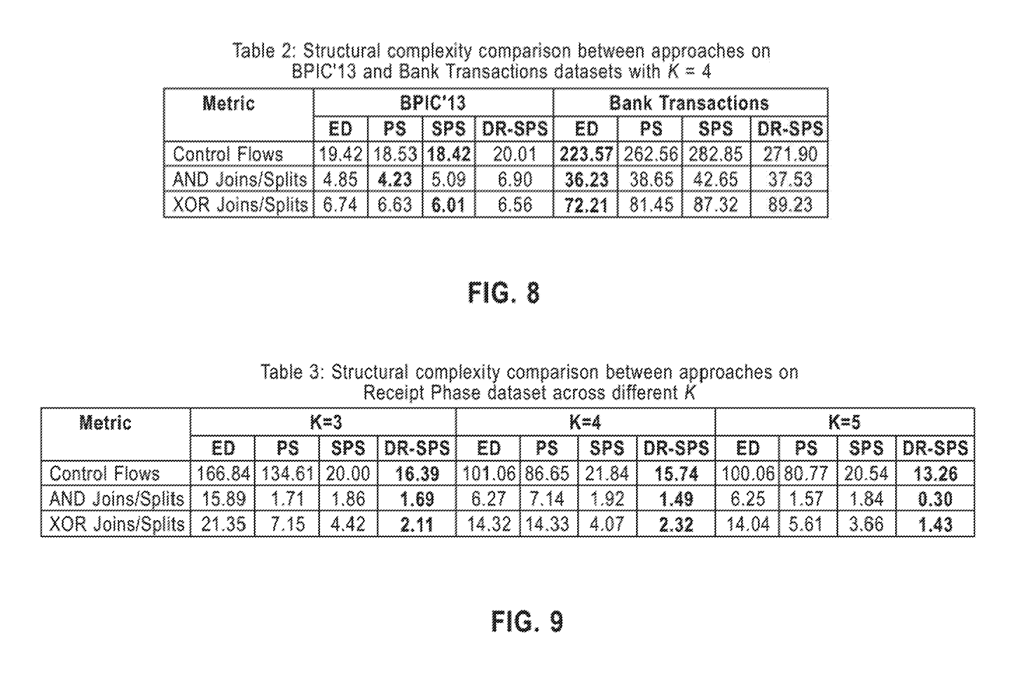

Table 2, illustrated in FIG. 8, shows a comparison of the weighted structural complexity scores between approaches across different structural metrics, the XOR Joins/Splits, AND Joins/Splits, and Control Flows, for the BPIC'13 and Bank Transactions datasets, where the number of clusters k=4. Table 3, illustrated in FIG. 9, shows a comparison of structural complexity between approaches on Receipt Phase dataset across a varying number of clusters k.

Overall, the results highlight that approaches according to embodiments can outperform the baseline ED approach by producing clusters of simpler process models. The outperformance is clear for the Receipt Phase dataset across different number of clusters and in BPIC'13 dataset. Although an ED approach produces clusters with less complex process models in the Bank Transactions dataset, the difference is not significant. Moreover, approaches according to embodiments have improved conformance fitness and efficiency over the baseline.

### Dimension Reduction Comparison

Further experiments according to embodiments focus on evaluating the effectiveness and efficiency of using DR-SPS and SPS approaches according to embodiments. Recall that a DR-SPS approach according to an embodiment uses dimension reduction methods while a SPS approach according to an embodiment does not.

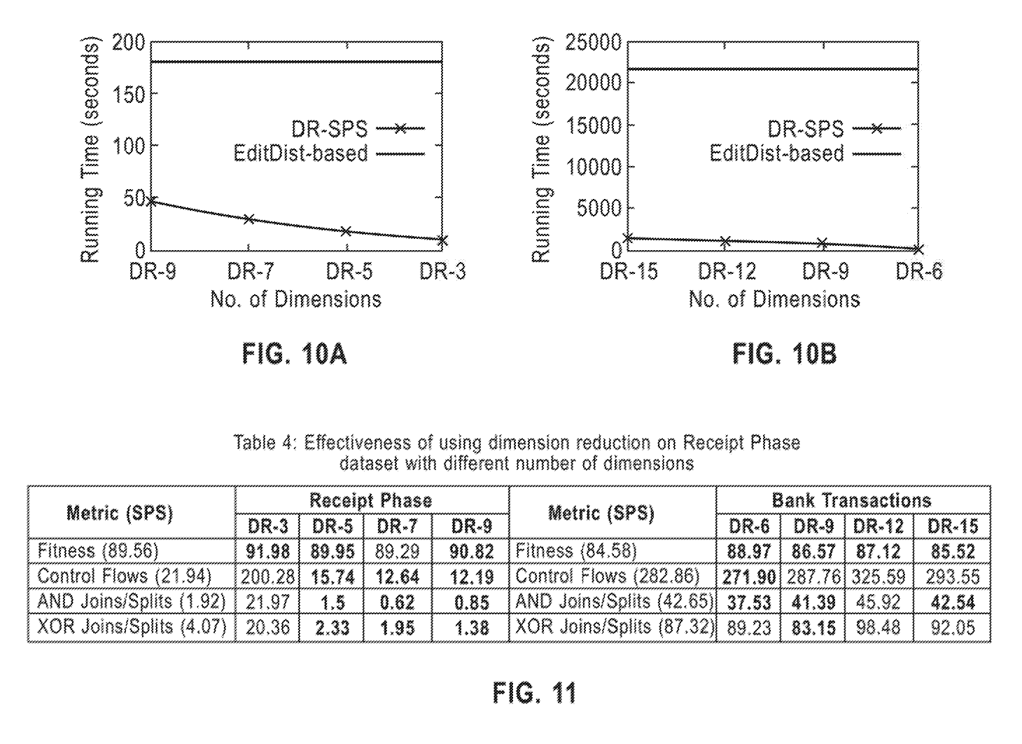

FIGS. 10(a)-(b) illustrate a running time comparison between with and without dimension reduction, specifically a running time comparison between a DR-SPS approach according to an embodiment and an SPS approach according to an embodiment on the Receipt Phase (FIG. 10(a)) and the Bank Transaction (FIG. 10(B)) datasets. In the figure, DR-n means a DR-SPS approach according to an embodiment with n dimensions. A DR-SPS approach according to an embodiment can outperform an SPS approach according to an embodiment with up to 9× speed-up on the Receipt Phase dataset, with 27 dimensions, and up to 100× speed-up on the Bank Transaction dataset, with 113 dimensions.

Table 4, shown in FIG. 11, show fitness and structural complexity comparison results between a DR-SPS approach according to an embodiment, with a different number of dimensions, and an SPS approach according to an embodiment. In the table, the SPS results are displayed in parentheses. The results show that a DR-SPS approach according to an embodiment can outperform an SPS approach according to an embodiment in most cases, indicated by the bold-face numbers, in both fitness and structural complexity metrics. This result is interesting and somewhat surprising as it is generally expected that dimension reduction for edit distance-based approach only benefits the efficiency and trade-off the effectiveness. In fact, the results show that a DR-SPS approach according to an embodiment with dimension reduction can achieve both objectives.

### System Implementations

It is to be understood that embodiments of the present disclosure can be implemented in various forms of hardware, software, firmware, special purpose processes, or a combination thereof. In one embodiment, an embodiment of the present disclosure can be implemented in software as an application program tangible embodied on a computer readable program storage device. The application program can be uploaded to, and executed by, a machine comprising any suitable architecture. Furthermore, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. An automatic troubleshooting system according to an embodiment of the disclosure is also suitable for a cloud implementation.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

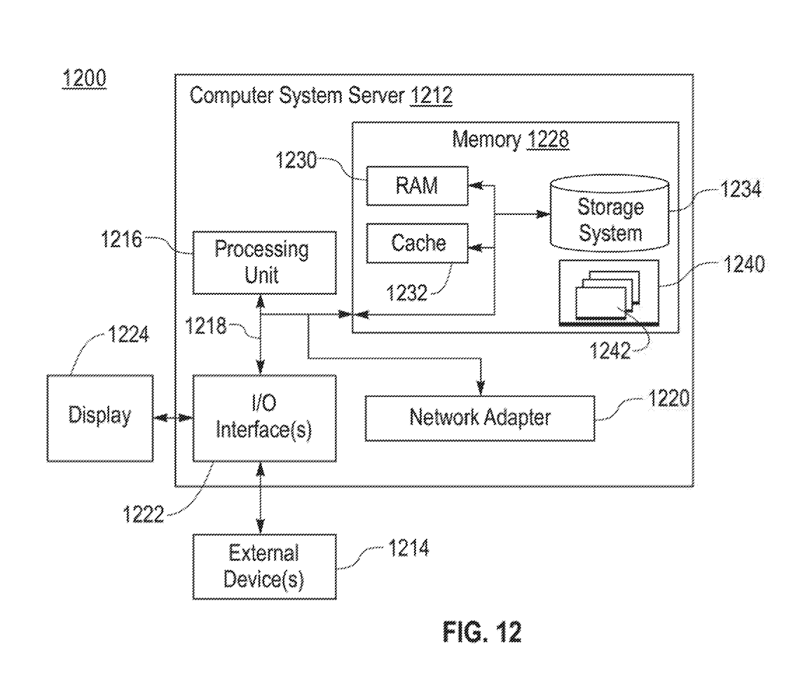

Referring now to FIG. 12, a schematic of an example of a cloud computing node is shown. Cloud computing node 1200 is only one example of a suitable cloud computing node and is not intended to suggest any limitation as to the scope of use or functionality of embodiments of the disclosure described herein. Regardless, cloud computing node 1200 is capable of being implemented and/or performing any of the functionality set forth hereinabove.

In cloud computing node 1200 there is a computer system/server 1212, which is operational with numerous other general purpose or special purpose computing system environments or configurations. Examples of well-known computing systems, environments, and/or configurations that may be suitable for use with computer system/server 1212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1212 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 1212 in cloud computing node 1210 is shown in the form of a general-purpose computing device. The components of computer system/server 1212 may include, but are not limited to, one or more processors or processing units 1216, a system memory 1228, and a bus 1218 that couples various system components including system memory 1228 to processor 1216.

Bus 1218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1212 typically includes a variety of computer system readable media. Such media may be any available media that is accessible by computer system/server 1212, and it includes both volatile and non-volatile media, removable and non-removable media.

System memory 1228 can include computer system readable media in the form of volatile memory, such as random access memory (RAM) 1230 and/or cache memory 1232. Computer system/server 1212 may further include other removable/non-removable, volatile/non-volatile computer system storage media. By way of example only, storage system 1234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1218 by one or more data media interfaces. As will be further depicted and described below, memory 1228 may include at least one program product having a set (e.g., at least one) of program modules that are configured to carry out the functions of embodiments of the disclosure.

Program/utility 1240, having a set (at least one) of program modules 1242, may be stored in memory 1228 by way of example, and not limitation, as well as an operating system, one or more application programs, other program modules, and program data. Each of the operating system, one or more application programs, other program modules, and program data or some combination thereof, may include an implementation of a networking environment. Program modules 1242 generally carry out the functions and/or methodologies of embodiments of the disclosure as described herein.

Computer system/server 1212 may also communicate with one or more external devices 1214 such as a keyboard, a pointing device, a display 1224, etc.; one or more devices that enable a user to interact with computer system/server 1212; and/or any devices (e.g., network card, modem, etc.) that enable computer system/server 1212 to communicate with one or more other computing devices. Such communication can occur via Input/Output (I/O) interfaces 1222. Still yet, computer system/server 1212 can communicate with one or more networks such as a local area network (LAN), a general wide area network (WAN), and/or a public network (e.g., the Internet) via network adapter 1220. As depicted, network adapter 1220 communicates with the other components of computer system/server 1212 via bus 1218. It should be understood that although not shown, other hardware and/or software components could be used in conjunction with computer system/server 1212. Examples, include, but are not limited to: microcode, device drivers, redundant processing units, external disk drive arrays, RAID systems, tape drives, and data archival storage systems, etc.

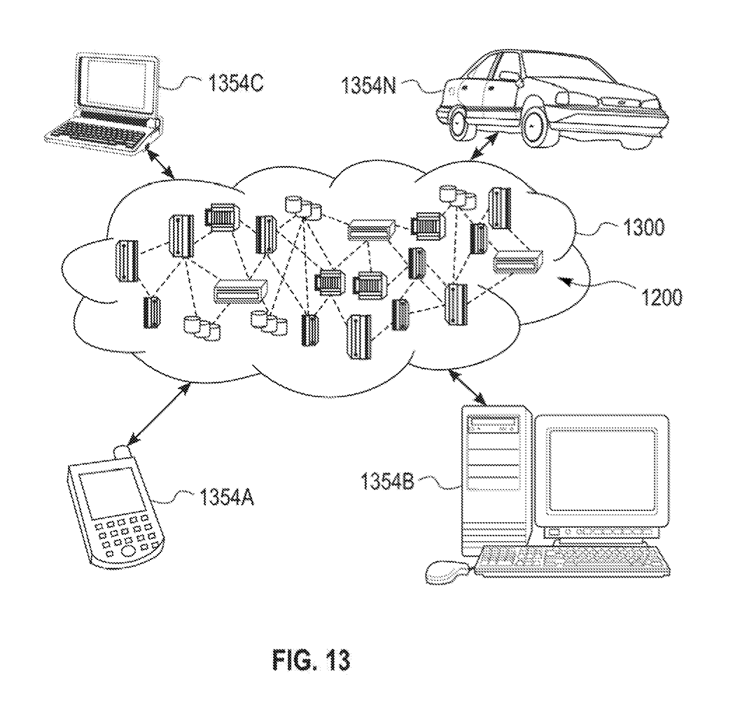

Referring now to FIG. 13, illustrative cloud computing environment 1300 is depicted. As shown, cloud computing environment 1300 comprises one or more cloud computing nodes 1200 with which local computing devices used by cloud consumers, such as, for example, personal digital assistant (PDA) or cellular telephone 1354A, desktop computer 1354B, laptop computer 1354C, and/or automobile computer system 1354N may communicate. Nodes 1200 may communicate with one another. They may be grouped (not shown) physically or virtually, in one or more networks, such as Private, Community, Public, or Hybrid clouds as described hereinabove, or a combination thereof. This allows cloud computing environment 1300 to offer infrastructure, platforms and/or software as services for which a cloud consumer does not need to maintain resources on a local computing device. It is understood that the types of computing devices 1354A-N shown in FIG. 13 are intended to be illustrative only and that computing nodes 1200 and cloud computing environment 1300 can communicate with any type of computerized device over any type of network and/or network addressable connection (e.g., using a web browser).

While embodiments of the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A computer-implemented method of generating process models from process event logs, comprising the steps of:
receiving an identification of node types and edge types of an application event log to generate a heterogeneous information network graph of the application event log, wherein node types include events and traces, wherein each trace is a finite sequence of event type nodes;
reducing a number of event types of the set of input traces to generate clusters of new event types; and
clustering the set of input traces to generate a plurality of disjoint partitions based on the clusters of new event types, wherein the clustering maximizes an average fitness of each partition and minimizes an average complexity of each partition, wherein each partition is a graph model of a process in the application event log.

2. The method of claim 1, further comprising filtering the events in the application event log to select those entries that contain attributes needed for generating process models.

3. The method of claim 1, further comprising generating a set of meta-paths that connect nodes of a same type in the application event log.

4. The method of claim 3, further comprising, if the number of nodes in the set of meta-paths is large, based on user provided cost/time constraints, determining a sample size of a reduced set of meta-paths.

5. The method of claim 1, further comprising receiving a number of reduced dimensions.

6. The method of claim 1, further comprising presenting a visualization of the plurality of disjoint partitions to a user, and prompting the user to either accept the plurality of disjoint partitions or to enter new parameters to repeat the generation of process models.

7. The method of claim 4, wherein clustering the set of input traces further comprises creating a hierarchy of the plurality of disjoint partitions by successively merging pairs of events that are closest to each other until all clusters have been merged into a single hierarchical cluster that contains all events, where each leaf node of the single hierarchical cluster is an event and a root of the single hierarchical cluster is the single hierarchical cluster formed by the last merge.

8. The method of claim 7, wherein clustering the set of input traces further comprises cutting the hierarchy to obtain a desirable number of clusters by finding a minimum similarity threshold so that a distance between any two events in the same cluster is no more than that minimum similarity threshold, wherein the desirable number of clusters is the same as the number of reduced event types.

9. The method of claim 1, further comprising assembling event type nodes into a set of input traces.

10. A computer-implemented method of generating process models from process event logs, comprising the steps of:
receiving a heterogeneous information network (HIN) graph of an application event log and a set of meta-paths, wherein nodes of the HIN graph include event type nodes and trace type nodes, wherein each trace type node is associated with a finite sequence of event type nodes, and each meta-path of the set of meta-paths connect nodes of a same type in the HIN graph; calculating a path similarity between each pair of events type nodes in the HIN graph connected by a meta-path P using
$${σ}_{{P}_{EE}} ( {e}_{j} , {e}_{k} ) = \frac{2 \times \vert {Γ}_{P} ( {e}_{j} , {e}_{k} ) \vert}{\vert {Γ}_{P} ( {e}_{j} , {e}_{j} ) \vert + \vert {Γ}_{P} ( {e}_{k} , {e}_{k} ) \vert}$$
wherein eⱼ and eₖ represent event-type nodes and Γ_{P}(eⱼ, eₖ) is a set of paths from eⱼ to eₖ following meta-path P;
reducing a number of dimensions of a matrix representation of event type nodes and the trace type nodes to generate a set of new dimensions for the event type nodes;
calculating a similarity between each pair of event type nodes Sⱼₖ=sim′(eⱼ, eₖ)=(1−λ)×sim(eⱼ, eₖ)+λ×σ_{P}_{_{EE}} (eⱼ, eₖ), wherein sim(eⱼ, eₖ) is a similarity between eⱼ and eₖ on the set of new dimensions, λ is a user supplied parameter, and Sⱼₖ is an element of a similarity matrix defined by each pair of event type nodes on the set of new dimensions;
merging each event eⱼ into a cluster associated with one of the new dimensions that contains an event closest to eⱼ, using
ρ(eⱼ)=ρ(e*) with respect to e*=arg maxₑ_{ₖ}_{εE}sim′(eⱼ,eₖ),
until all clusters have been merged into a single cluster that contains all events to create a hierarchy H in which each leaf node is an event and a root is a single cluster of the last merge; and
cutting the hierarchy to obtain a desirable number of clusters by finding a minimum similarity threshold so that a distance between any two events in the same cluster is no more than that minimum similarity threshold, wherein the desirable number of clusters is the same as the number of new dimensions.

11. The method of claim 10, further comprising assembling the event type nodes into a set of input traces, wherein the set of input traces is represented by a matrix M of size |T|×|E|, wherein |T| is a number of sets of traces, and |E| is a number of event type nodes, where each row of M is a trace vector t=(s₁, s₂, . . . , s_{|E|}) wherein
$${s}_{i} = \{ \begin{matrix}( 1 + log ( {f}_{{e}_{i} , t} ) ) \times log ( \frac{\vert T \vert}{{n}_{{e}_{i}}} ) & if {e}_{i} ∈ t , \\ 0 & otherwise .\end{matrix} ,$$
wherein fₑ_{ᵢ}_{,t} is a normalized frequency of event eᵢ in trace t, and nₑ_{ᵢ}=|{tεT, eᵢεt}| is a popularity of event eᵢ across all traces.

12. The method of claim 11, wherein reducing a number of dimensions comprises calculating a matrix M′ of size |T|×κ, wherein κ<<|E| is a number of new dimensions that represents the original data on the new dimensions, where each row is a trace vector, and calculating a matrix W of size |E|×κ that represents a mapping of previous dimensions to the new dimensions κ, which are represented as a set of κ clusters C={Cᵢ}, 1≦i≦κ, and mapping ρ: E→C maps each event eεE to a cluster in C.

13. The method of claim 10, wherein sim(eⱼ, eₖ) is one of a cosine similarity or a Euclidean distance-based similarity.

14. The method of claim 10, further comprising receiving an identification of nodes and edges of the application event log to generate the I-TIN graph of the application event log, and receiving an identification of node types of the nodes.

15. A non-transitory program storage device readable by a computer, tangibly embodying a program of instructions executed by the computer to perform the method steps for generating process models from process event logs, comprising the steps of:
receiving an identification of node types and edge types of an application event log to generate a heterogeneous information network graph of the application event log, wherein node types include events and traces, wherein each trace is a finite sequence of event type nodes;
reducing a number of event types of the set of input traces to generate clusters of new event types; and
clustering the set of input traces to generate a plurality of disjoint partitions based on the clusters of new event types, wherein the clustering maximizes an average fitness of each partition and minimizes an average complexity of each partition, wherein each partition is a graph model of a process in the application event log.

16. The computer readable program storage device of claim 15, the method further comprising filtering the events in the application event log to select those entries that contain attributes needed for generating process models.

17. The computer readable program storage device of claim 15, the method further comprising generating a set of meta-paths that connect nodes of a same type in the application event log.

18. The computer readable program storage device of claim 17, the method further comprising, if the number of nodes in the set of meta-paths is large, based on user provided cost/time constraints, determining a sample size of a reduced set of meta-paths.

19. The computer readable program storage device of claim 15, the method further comprising receiving a number of reduced dimensions.

20. The computer readable program storage device of claim 15, the method further comprising presenting a visualization of the plurality of disjoint partitions to a user, and prompting the user to either accept the plurality of disjoint partitions or to enter new parameters to repeat the generation of process models.

21. The computer readable program storage device of claim 18, wherein clustering the set of input traces further comprises creating a hierarchy of the plurality of disjoint partitions by successively merging pairs of events that are closest to each other until all clusters have been merged into a single hierarchical cluster that contains all events, where each leaf node of the single hierarchical cluster is an event and a root of the single hierarchical cluster is the single hierarchical cluster formed by the last merge.

22. The computer readable program storage device of claim 21, wherein clustering the set of input traces further comprises cutting the hierarchy to obtain a desirable number of clusters by finding a minimum similarity threshold so that a distance between any two events in the same cluster is no more than that minimum similarity threshold, wherein the desirable number of clusters is the same as the number of reduced event types.

23. The computer readable program storage device of claim 15, the method further comprising assembling event type nodes into a set of input traces.
